(19) United States
(12) Patent Application Publication
(10) Pub. No.: US 2026/0238122 A1
(43) Pub. Date: Aug. 13, 2026

(54) LIGHT-EMISSION DRIVE DEVICE, LIGHT-EMITTING DEVICE, AND LIGHT-EMITTING SYSTEM

(71) Applicant: ROHM CO., LTD., Kyoto-shi (JP)

(72) Inventors: Shinsuke TAKAGIMOTO, Kyoto-shi (JP); Masaaki NAKAYAMA, Kyoto-shi (JP)

(21) Appl. No.: 19/536,337

(22) Filed: Feb. 11, 2026

(30) Foreign Application Priority Data
Feb. 13, 2025 (JP) 2025-021488

(51) Int. Cl. H02M 1/36; H02M 1/00; H02M 3/07

(52) U.S. Cl. CPC H02M 1/36; H02M 1/0009; H02M 3/07

(57) ABSTRACT

The light-emission drive device includes a bypass circuit and a bypass control circuit. The bypass circuit is configured to switch over between an inflow state and a withdrawal state for each of light-emitting elements connected in series in plurality. The bypass control circuit controls the bypass circuit in such a way that when an enable signal is at a first logic level, a drive current is made to flow into, or be withdrawn from, each of the light-emitting elements, and when the enable signal is at a second logic level, the drive current is made to flow into none of the light-emitting elements but to be withdrawn from all the light-emitting elements until the drive current becomes less than a specified current value.

### CROSS REFERENCE TO RELATED APPLICATIONS

The present invention claims priority under 35 U.S.C. §119 to Japanese Application No. 2025-021488 filed February 13, 2025, the entire contents of which are hereby incorporated by reference.

### BACKGROUND OF THE INVENTION

### 1. Field of the Invention

The present invention relates to a light-emission drive device, a light-emitting device, and a light-emitting system.

### 2. Description of Related Art

Conventionally, there has been provided a light-emission drive device capable of on/off (lighting/extinguishing) control for light emission of plural light-emitting elements.

### SUMMARY OF THE DISCLOSURE

A light-emission drive device according to the present disclosure includes a bypass circuit and a bypass control circuit. The bypass circuit is configured to switch over between an inflow state, in which a drive current is made to flow into each of light-emitting elements connected in series in plurality, and a withdrawal state, in which the drive current is made not to flow but to be withdrawn. The bypass control circuit is configured to control the bypass circuit in such a way that when an externally inputted enable signal is at a first logic level, the drive current is made to flow into, or be withdrawn from, each of the light-emitting elements, and when the enable signal is at a second logic level, the drive current is made to flow into none of the light-emitting elements but to be withdrawn from all the light-emitting elements until the drive current becomes less than a specified current value.

A light-emitting device according to the disclosure includes a plurality of the light-emitting elements, and the light-emission drive device of the above-described configuration.

A light-emitting system according to the disclosure includes the light-emitting device of the above-described configuration, and a power supply device configured to generate the drive current based on the enable signal and supply the drive current to the light-emitting device.

### BRIEF DESCRIPTION OF THE DRAWINGS

FIG. 1 is a diagram showing a configuration of a light-emitting system.

FIG. 2 is a diagram showing an internal configuration of a light-emitting device.

FIG. 3 is a timing chart showing timings of light-emission control over a light-emitting element array.

FIG. 4 is a timing chart showing a time lag between an enable signal inputted to a power supply unit and an enable signal inputted to the light-emitting device.

FIG. 5 is a timing chart showing an enable signal inputted to the power supply unit and an enable signal inputted to the light-emitting device.

FIG. 6 is a diagram showing a configuration of a light-emitting device according to a first embodiment.

FIG. 7 is a timing chart showing delays of a charge enable and a power supply enable.

FIG. 8 is a diagram showing an example of internal configuration of a delay control circuit.

FIG. 9 is a diagram showing an internal configuration of a delay control circuit which is another example.

FIG. 10 is a timing chart showing internal control in the configuration example.

FIG. 11 is a diagram showing a configuration of a gate driver.

FIG. 12 is a diagram showing a light-emitting device according to a second embodiment.

FIG. 13 is a diagram showing a light-emitting device according to a third embodiment.

FIG. 14 is a diagram showing a light-emitting system equipped with a plurality of light-emitting devices.

### DESCRIPTION OF THE PREFERRED EMBODIMENTS

### Detailed Description

### Basic configuration of light-emitting system 100

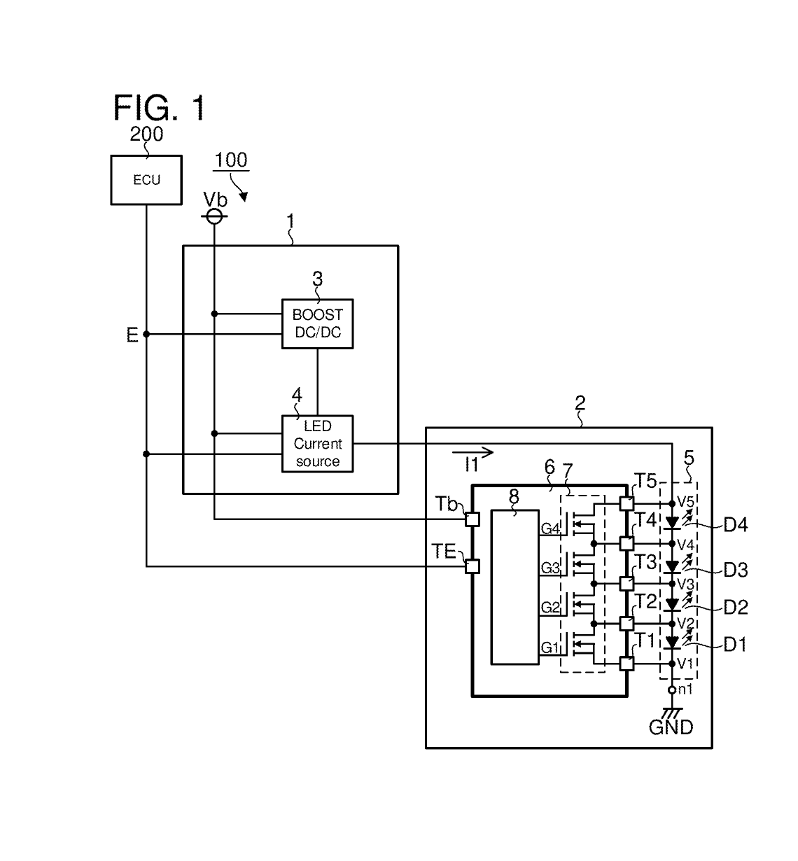

First, a basic configuration of a light-emitting system 100 will be described. FIG. 1 is a diagram showing a configuration of the light-emitting system 100. As shown in FIG. 1, the light-emitting system 100 receives input of an enable signal E from an ECU (Electronic Control Unit) 200. The ECU 200 is a central processing circuit such as a microcomputer that exercises centralized control over the light-emitting system 100. The enable signal E is a digital signal that switches between binary logic levels, high and low levels.

In response to the enable signal E, the light-emitting system 100 executes or halts drive control over light-emitting elements (later-described light-emitting elements D1 to D4 in the case of this figure) that are included in the system itself. For example, when the enable signal E is at high level, the light-emitting system 100 drives and controls the individual light-emitting elements. Conversely, when the enable signal E is at low level, the light-emitting system 100 extinguishes the individual light-emitting elements, leading to a system halt state.

The light-emitting system 100 includes a power supply unit 1 and a light-emitting device 2. The power supply unit 1 receives input of the enable signal E. Also, the power supply unit 1 operates on supply of a battery voltage Vb. The power supply unit 1 generates a drive current I1, and supplies the current to the light-emitting device 2. This is explained below in detail.

The power supply unit 1 includes a booster circuit 3 and a drive-current generation circuit 4. The booster circuit 3 receives input of an enable signal E. Also, the booster circuit 3 operates on supply of the battery voltage Vb. In response to the enable signal E, the booster circuit 3 generates a boost voltage Vo derived from boosting of the battery voltage Vb. The booster circuit 3 supplies the boost voltage Vo to the drive-current generation circuit 4.

The drive-current generation circuit 4 receives input of the enable signal E and the boost voltage Vo. Also, the drive-current generation circuit 4 operates on supply of the battery voltage Vb. The drive-current generation circuit 4 generates a drive current I1 based on the enable signal E, the battery voltage Vb, and the boost voltage Vo. The drive-current generation circuit 4 supplies the drive current I1 to the light-emitting device 2 (more specifically, later-described light-emitting element array 5).

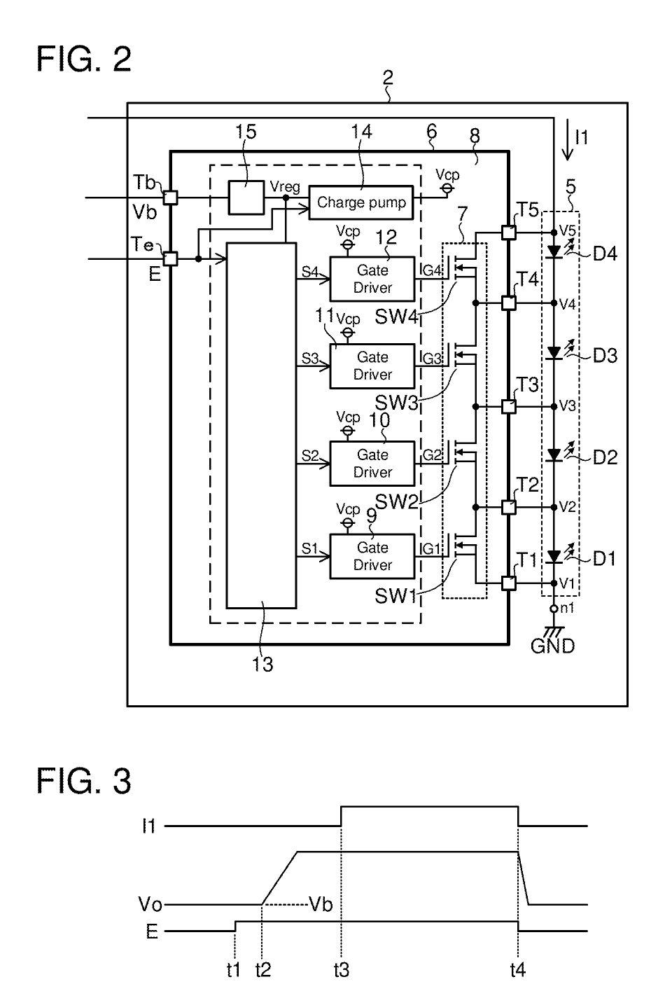

FIG. 2 is a diagram showing an internal configuration of the light-emitting device 2. As shown in FIGS. 1 and FIG. 2, the light-emitting device 2 receives input of an enable signal E. Also, the light-emitting device 2 operates on supply of the battery voltage Vb. The light-emitting device 2 further makes the light-emitting elements D1 to D4 based on the enable signal E and the drive current I1. This is explained below in detail.

The light-emitting device 2 includes a light-emitting element array 5 and a light-emission drive device 6. The light-emitting element array 5 includes a plurality of light-emitting elements (light-emitting elements D1 to D4 in the case of this figure). The light-emitting elements D1 to D4 are connected in series to one another. More specifically, an anode of the light-emitting element D4 is connected to the drive-current generation circuit 4. A cathode of the light-emitting element D4 is connected to an anode of the light-emitting element D3. A cathode of the light-emitting element D3 is connected to an anode of the light-emitting element D2. A cathode of the light-emitting element D2 is connected to an anode of the light-emitting element D1. A cathode of the light-emitting element D1 is connected to a node n1.

In addition, the node n1 in this case is connected to a grounding terminal GND. Instead, the node n1 may be connected to a specified circuit other than the grounding terminal GND.

The light-emission drive device 6 includes a battery terminal Tb and an enable terminal Te. The light-emission drive device 6 receives, via the enable terminal Te, input of an enable signal E. Also, the light-emission drive device 6 operates on supply of the battery voltage Vb via the battery terminal Tb. The light-emission drive device 6 controls light emission of the light-emitting element array 5 in response to the enable signal E. A concrete configuration of the light-emission drive device 6 is as follows.

The light-emission drive device 6 includes a bypass circuit 7 and a bypass control circuit 8. The light-emission drive device 6 is a semiconductor integrated circuit (IC) in which the bypass circuit 7 and the bypass control circuit 8 are integrated together.

The bypass circuit 7 is so configured as to switch to a current inflow state, in which the drive current I1 is made to flow into the individual light-emitting elements D1 to D4, or to a current withdrawal state, in which the drive current I1 is not passed to but withdrawn from the light-emitting elements D1 to D4.

The bypass circuit 7 is equipped with a plurality of switch elements (switch elements SW1 to SW4 in the case of this figure). The switch elements SW1 to SW4 are N-channel MOSFETs (Metal-Oxide-Semiconductor Field-Effect Transistors). The switch elements SW1 to SW4 are connected in parallel to the light-emitting elements D1 to D4, respectively. This is explained below in detail.

A source of the switch element SW1 is connected to the cathode of the light-emitting element D1 via a terminal T1. A drain of the switch element SW1 is connected, together with a source of the switch element SW2, to the anode of the light-emitting element D1 and the cathode of the light-emitting element D2 via a terminal T2.

A drain of the switch element SW2 is connected, together with a source of the switch element SW3, to the anode of the light-emitting element D2 and the cathode of the light-emitting element D3 via a terminal T3. A drain of the switch element SW3 is connected, together with a source of the switch element SW4, to the anode of the light-emitting element D3 and the cathode of the light-emitting element D4 via a terminal T4. A drain of the switch element SW4 is connected to the anode of the light-emitting element D4 via a terminal T5.

Individual gates of the switch elements SW1 to SW4 are given input of drive signals G1 to G4 from the bypass control circuit 8 (more specifically, later-described gate drivers 9 to 12). The switch elements SW1 to SW4 are turned on/off in response to the drive signals G1 to G4 inputted to the gates of the switch elements themselves, respectively.

For example, while the switch element SW4 is in on-status, the drive current I1 does not flow into the light-emitting element D4 but flows into the switch element SW4. In this case, the light-emitting element D4 comes to a current withdrawal state, with the light turned off. Conversely, while the switch element SW4 is in off-state, the drive current I1 flows into the light-emitting element D4. In this case, the light-emitting element D4 comes to a current inflow state, with the light turned on.

Similarly, the light-emitting element D3 is switched to any one of the current withdrawal state and the current inflow state in response to on/off status of the switch element SW3. Also, the light-emitting element D2 is switched to any one of the current withdrawal state and the current inflow state in response to on/off status of the switch element SW2. The light-emitting element D1 is switched to any one of the current withdrawal state and the current inflow state in response to on/off status of the switch element SW1.

The bypass control circuit 8 generates drive signals G1 to G4 in response to the enable signal E. This is explained below in detail. The bypass control circuit 8 includes an internal power supply circuit 15, gate drivers 9 to 12, a main control circuit 13, and a charge pump 14.

The internal power supply circuit 15, upon receiving supply of the battery voltage Vb, generates an internal power supply voltage Vreg. The internal power supply circuit 15 supplies the internal power supply voltage Vreg to the gate drivers 9 to 12, the main control circuit 13, and the charge pump 14.

The main control circuit 13 operates on supply of the internal power supply voltage Vreg. The main control circuit 13 receives input of the enable signal E. The main control circuit 13 generates control signals S1 to S4 based on the enable signal E. The main control circuit 13 inputs the control signals S1 to S4 into the gate drivers 9 to 12, respectively.

The charge pump 14 receives input of the enable signal E. Also, the charge pump 14 is supplied with the internal power supply voltage Vreg. The charge pump 14, in response to the enable signal E, boosts the internal power supply voltage Vreg to generate a charge voltage Vcp. The charge pump 14 supplies the charge voltage Vcp to the gate drivers 9 to 12.

The gate drivers 9 to 12 generate drive signals G1 to G4 based on the charge voltage Vcp in response to the control signals S1 to S4 inputted to the gate drivers themselves, respectively.

A voltage developed to the terminal T1 is assumed as voltage V1, and similarly assumed are a voltage developed to the terminal T2 as voltage V2, a voltage developed to the terminal T3 as voltage V3, a voltage developed to the terminal T4 as voltage V4, and a voltage developed to the terminal T5 as voltage V5.

A voltage value of the high-level drive signal G1 is set so as to exceed a sum value of the voltage V1 and an on-threshold voltage of the switch element SW1. Because of this setting, when the drive signal G1 is at high level, the switch element SW1 is turned on securely. Also when the drive signal G1 is at low level, the switch element SW1 is turned off.

A voltage value of the high-level drive signal G2 is set so as to exceed a sum value of the voltage V2 and an on-threshold voltage of the switch element SW2. Because of this setting, when the drive signal G2 is at high level, the switch element SW2 is turned on securely. Also when the drive signal G2 is at low level, the switch element SW2 is turned off.

A voltage value of the high-level drive signal G3 is set so as to exceed a sum value of the voltage V3 and an on-threshold voltage of the switch element SW3. Because of this setting, when the drive signal G3 is at high level, the switch element SW3 is turned on securely. Also when the drive signal G3 is at low level, the switch element SW3 is turned off.

A voltage value of the high-level drive signal G4 is set so as to exceed a sum value of the voltage V4 and an on-threshold voltage of the switch element SW4. Because of this setting, when the drive signal G4 is at high level, the switch element SW4 is turned on securely. Also when the drive signal G4 is at low level, the switch element SW4 is turned off.

Besides, a relational expression holds that drive signal G4 > drive signal G3 > drive signal G2 > drive signal G1. That is, connected to sources of the switch elements SW2 to SW4 are drains of their neighboring switch elements SW1 to SW3, respectively. Therefore, the switch elements SW2 to SW4 are increased in gate-source voltage by increments equivalent to drain voltages of their neighboring switch elements SW1 to SW3, respectively. This is the reason that the above relationship holds.

The charge pump 14 generates a charge voltage Vcp that allows all the switch elements SW1 to SW4 to be turned on/off. More specifically, the charge pump 14 sets a voltage value of the charge voltage Vcp to a level higher than the high-level drive signal G4 of the highest voltage.

As the enable signal E rises to high level, light-emission control over the light-emitting element array 5 is exercised. This is explained below in detail.

### Control example of light-emitting system 100

FIG. 3 is a timing chart showing timings of light-emission control over the light-emitting element array 5. Shown in FIG. 3, from above in order, are a drive current I1, a boost voltage Vo, and an enable signal E.

As shown in FIG. 3, when time t1 has come up, the enable signal E rises to high level. The booster circuit 3, receiving input of the high-level enable signal E, starts boost operation based on the battery voltage Vb. Thereafter, when time t2 has come up, the boost voltage Vo starts to increase. After the boost voltage Vo increasing to a specified value, when time t3 has come up, the drive-current generation circuit 4 generates a drive current I1 based on the boost voltage Vo. The drive current I1 flows into the light-emitting device 2.

When time t4 has come up, the enable signal E falls to low level. The booster circuit 3, receiving input of the low-level enable signal E, ends the boost operation. Accordingly, the boost voltage Vo lowers at and after the time t4. Also, the drive-current generation circuit 4, receiving input of the low-level enable signal E, ends the generation of the drive current I1. As a result, the drive current I1 no longer flows to the light-emitting device 2.

Consequently, the light-emission drive device 6 controls light emission of the light-emitting elements D1 to D4 during a period from time t3 until time t4. When the time t4 has come up, the light-emission drive device 6 halts drive of the light-emitting elements D1 to D4 while extinguishing the light.

### Discussions on flashlight of light-emitting elements

As described above, the light-emitting system 100 drives and controls its own light-emitting elements (light-emitting elements D1 to D4) in response to the enable signal E. In this case, the enable signal E is inputted to both the power supply unit 1 and the light-emitting device 2 in the light-emitting system 100. Therefore, each of the power supply unit 1 and the light-emitting device 2 switches between operational start and halt of themselves in response to logic level of the enable signal E inputted thereto.

In this connection, when the light-emitting device 2 has halted operation under a condition that the drive current I1 is flowing to the light-emitting device 2, there is a fear that the light-emitting elements D1 to D4 may flash light. The term, flashlight, means that light is emitted instantaneously. When the light-emitting elements D1 to D4 under an extinguished state have flashed at a halt timing of the light-emitting system 100, it can be said that the light-emitting elements D1 to D4 have emitted light at a timing when the light-emitting elements D1 to D4 should properly keep light extinguished. Such behavior could be a considerable deviation from proper operation of the light-emitting system 100, undesirably.

One of causes of the flashlight is, for example, as follows. In one case, there has occurred a slight time lag of inputted enable signals E between the power supply unit 1 side and the light-emitting device 2 side. This time lag could occur, for example, due to a difference in wiring length of the enable signal E (more specifically, a difference between a wiring length from the ECU 200 to the power supply unit 1 and a wiring length from the ECU 200 to the light-emitting device 2), a difference in wiring resistance, noise, and the like.

When such a lag has occurred, it follows, in some cases, that there is no coincidence between an operation start/halt timing of the power supply unit 1 and an operation start/halt timing of the light-emitting device 2.

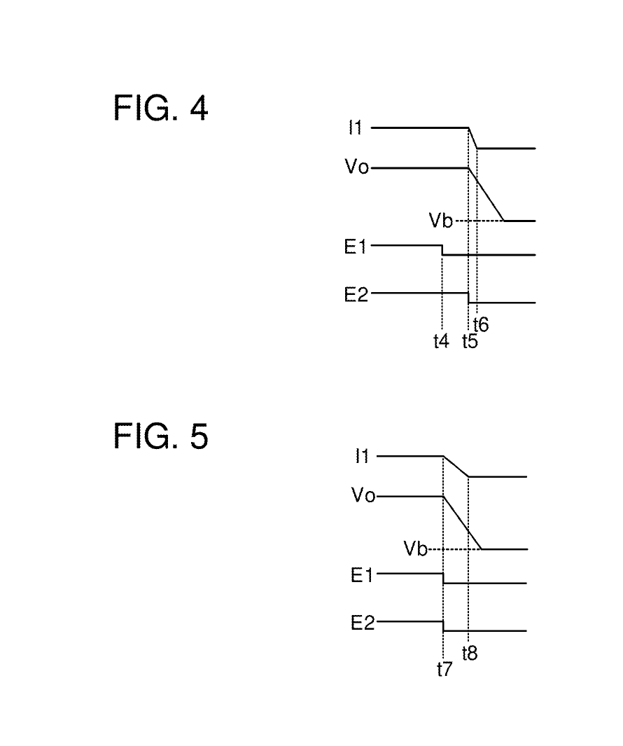

FIG. 4 is a timing chart showing a time lag between an enable signal E (here referred to as enable signal E1) inputted to the power supply unit 1 and an enable signal E (here referred to as enable signal E2) inputted to the light-emitting device 2.

As shown in FIG. 4, it is assumed that the enable signal E1 is lagged behind the enable signal E2. It is also assumed that the ECU 200 has lowered the enable signal E to low level. At immediately subsequent time t4', the enable signal E2 falls to low level. Meanwhile, the enable signal E1 is held still at high level at the time point of time t4'. At time t5 which is a slight lapse after time t4', the enable signal E1 falls to low level. Then, at time t6 which is a slight lapse after time t5, there no longer flows the drive current I1.

In such a case as shown above, at time t4', the light-emitting device 2 halts operation prior to the power supply unit 1. More specifically, under a condition that the drive current I1 is flowing on, operation of the charge pump 14 is halted. Therefore, supply of the charge voltage Vcp to the gate drivers 9 to 12 is halted. Then, whereas the drive current I1 is flowing on, the gates of the switch elements SW1 to SW4 come to high-impedance state. On this condition, the switch elements SW1 to SW4, which have kept turned on until immediately before time t4', can no longer maintain the on-status at and after time t4'. However, during a period from time t4' until time t6, the drive current I1 flows into the light-emitting device 2. Therefore, the light-emitting elements D1 to D4, which have been in the current withdrawal state, are switched over to the current inflow state, so that the drive current I1 may flow thereinto, causing occurrence of flashlight. Since the drive current I1 no longer flows at the time of coming-up of time t6, the light-emitting elements D1 to D4 are turned off; however, there is a possibility that flashlight may occur during the period from time t4' until time t6.

Another cause of the flashlight is as follows. As shown in FIG. 5 as an example, it is assumed that there has scarcely occurred a time lag between the enable signal E1 and the enable signal E2. In this case, as the ECU 200 has lowered the enable signal E to low level, the power supply unit 1 and the light-emitting device 2 halt operation generally simultaneously at time t7. However, when individual operations are delayed inside the light-emitting device 2 or when the drive current I1 flows to the light-emitting elements D1 to D4 due to residual charge, there is a possibility that the charge pump 14 may halt operation while the drive current I1 is being supplied to the light-emitting device 2. In this case, there may occur flashlight of the light-emitting elements D1 to D4 during a period from time t7, which is a falling-edge timing of the enable signal E2, until time t8, which is an end time of supply of the drive current I1 to the light-emitting device 2.

In view of the above-described issues, the light-emitting device 2 of the present disclosure is made capable of suppressing flashlight of the individual light-emitting elements (light-emitting elements D1 to D4) upon halts of the light-emitting system 100. Hereinbelow, light-emitting systems 100 according to individual embodiments of the disclosure will be described in detail.

### Light-emitting device 2 according to first embodiment of the disclosure

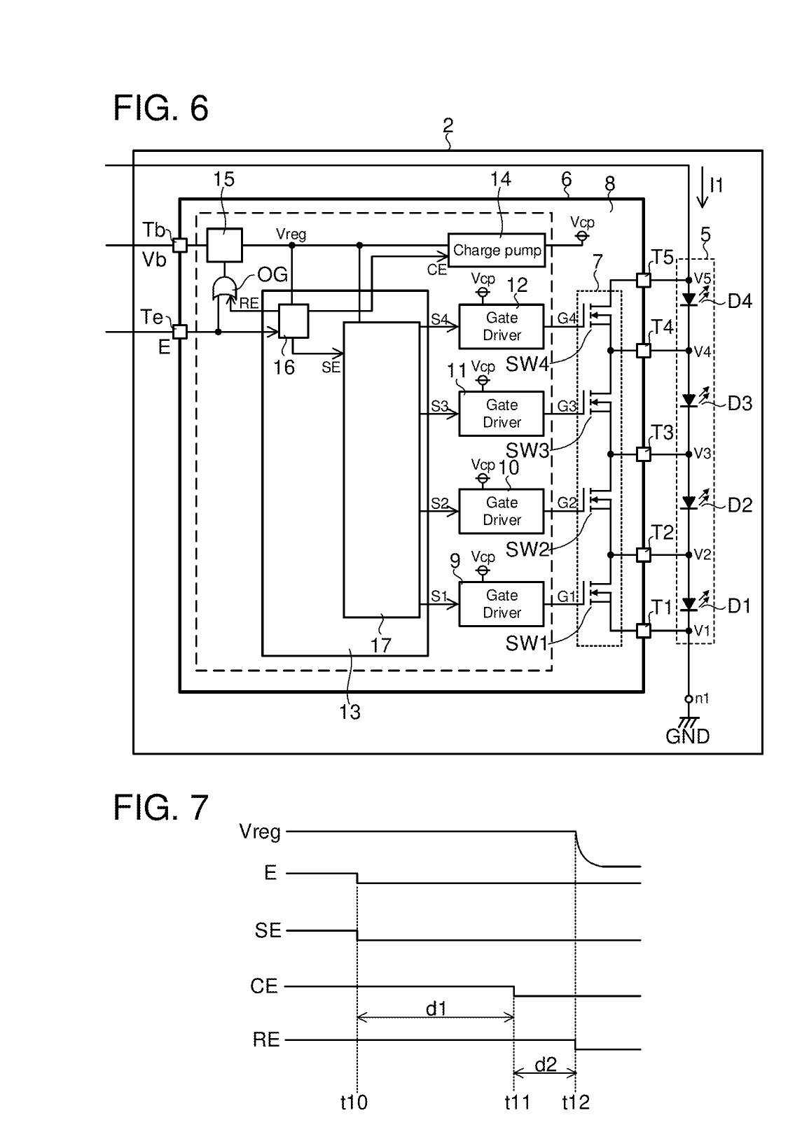

FIG. 6 is a diagram showing a configuration of a light-emitting device 2 according to a first embodiment. As shown in FIG. 6, a bypass control circuit 8 of the disclosure is equipped with an OR gate OG in addition to the above-described configuration components. A main control circuit 13 according to this disclosure is made capable of suppressing the above-described problems by virtue of its internal configuration. This is described concretely below.

The main control circuit 13 includes a delay control circuit 16 and a driver control circuit 17. The delay control circuit 16, in response to the enable signal E1, generates a power supply enable RE, a charge enable CE, and a switch drive enable SE.

The delay control circuit 16 generates the charge enable CE in a way that the charge enable CE is delayed against the power supply enable RE. The delay control circuit 16 also generates the switch drive enable SE in a way that the switch drive enable SE is delayed against the charge enable CE. Details of the delay control circuit 16 will be described later.

A first input terminal of the OR gate OG is connected to an enable terminal Te. A second input terminal of the OR gate OG is connected to the main control circuit 13. An output terminal of the OR gate OG is inputted to the internal power supply circuit 15.

The OR gate OG receives, at its first input terminal, input of the enable signal E1. The OR gate OG receives, at its second input terminal, input of the power supply enable RE. The OR gate OG sets a battery enable BE to high level when at least one of the enable signal E1 and the power supply enable RE is at high level. Also, the OR gate OG sets the battery enable BE to low level when both the enable signal E1 and the power supply enable RE are at low level.

The internal power supply circuit 15, receiving input of the high-level battery enable BE, generates an internal power supply voltage Vreg. Also, the internal power supply circuit 15, receiving input of the low-level battery enable BE, halts generation of the internal power supply voltage Vreg.

The charge pump 14, receiving input of the high-level charge enable CE, generates a charge voltage Vcp. Also, the charge pump 14, receiving input of the low-level charge enable CE, halts generation of the charge voltage Vcp.

The driver control circuit 17, receiving input of the high-level switch drive enable SE, sets the control signals S1 to S4 to arbitrary logic levels to arbitrarily control the gate drivers 9 to 12, respectively. That is, in this aspect, the light-emitting elements D1 to D4 are controlled each to an arbitrary light-emission state by the driver control circuit 17. Meanwhile, the driver control circuit 17, receiving input of the low-level switch drive enable SE, sets the control signals S1 to S4 to high level to control the gate drivers 9 to 12 so that the light-emitting elements D1 to D4 are turned off to an extinguished state.

### Control example of main control circuit 13

FIG. 7 is a timing chart showing delays of the charge enable CE and the power supply enable RE. As shown in FIG. 7, at time t10, the enable signal E1 falls to low level. In response to the falling edge of the enable signal E1, the main control circuit 13 sets the switch drive enable SE to low level without any intentional delay. Upon this level setting, the gate drivers 9 to 12 set the switch elements SW1 to SW4 to on-status. Thus, the light-emitting elements D1 to D4 are put into a current withdrawal state (= turned-off extinguished state) at time t10.

At time t11 which is an elapse of delay time d1 after time t10, the delay control circuit 16 lowers the charge enable CE to low level. In response to the falling edge of the charge enable CE, the charge pump 14 halts generation of the charge voltage Vcp. As a result, the gate drivers 9 to 12 halt generation of the drive signals G1 to G4. Therefore, at time t11, the gates of the switch elements SW1 to SW4 are put into a high-impedance state.

Then, at time t12 which is a delay time d2 after time t11, the delay control circuit 16 lowers the power supply enable RE to low level. Subsequently, the OR gate OG, receiving input of the low-level enable signal E1 and the low-level power supply enable RE, lowers the battery enable BE to low level. The internal power supply circuit 15 halts generation of the internal power supply voltage Vreg in response to the falling edge of the power supply enable RE. Therefore, at time t13 which is a relatively short time lapse after time t12, the internal power supply voltage Vreg goes to 0 V. Therefore, at time 13, the gate drivers 9 to 12, the main control circuit 13, and the charge pump 14 each come to a halted state. Thus, power consumption of the light-emitting device 2 during halts of the light-emitting system 100 is suppressed.

Accordingly, the delay time d1 may appropriately be set so that the supply of the drive current I1 to the light-emitting device 2 is ended during a period from a timing at which the ECU 200 has lowered the enable signal E to low level until time t11. By doing so, it follows that at a time point when the supply of the drive current I1 to the light-emitting device 2 is ended, the charge enable CE is maintained at high level so that the charge pump 14 has continued generating the charge voltage Vcp. Consequently, while the drive current I1 is being supplied to the light-emitting device 2 as described above, the gates of the switch elements SW1 to SW4 can be prevented from coming each to a high-impedance state. Furthermore, flashlight of the light-emitting elements D1 to D4 can be suppressed.

### Configuration example 1 of delay control circuit 16

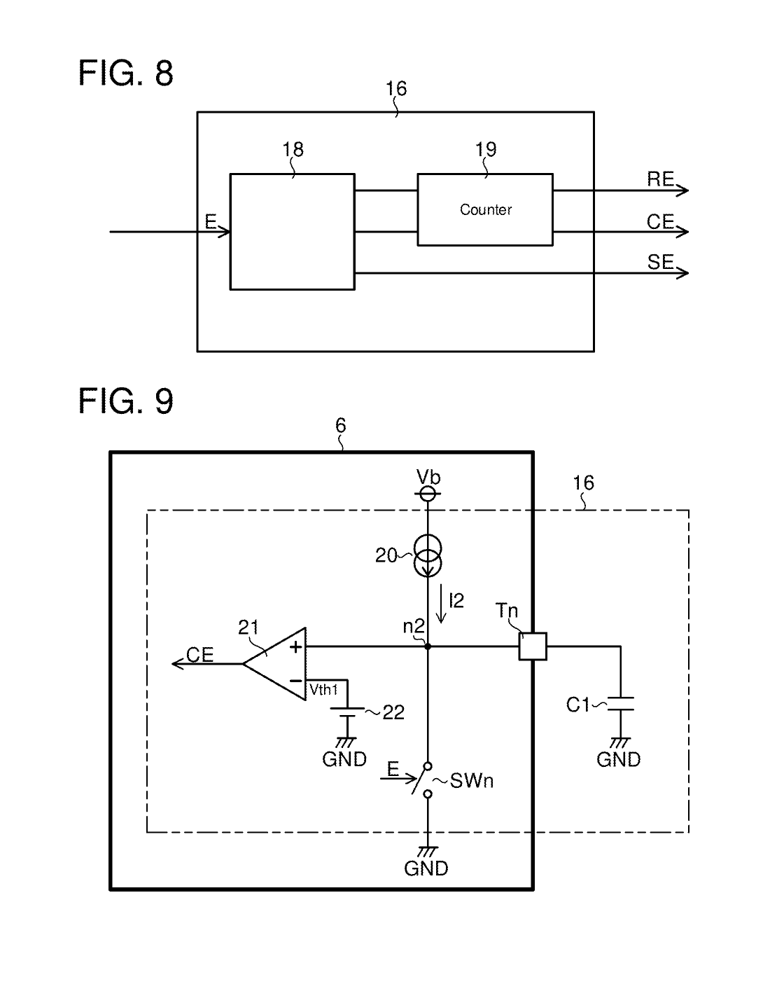

Next, an example of internal configuration of the delay control circuit 16 is described below. FIG. 8 is a diagram showing an example of internal configuration of the delay control circuit 16. As shown in FIG. 8, the delay control circuit 16 of this configuration example includes a signal generator 18 and a counter 19.

The signal generator 18, receiving input of the enable signal E1, generates a charge enable CE, a power supply enable RE, and a switch drive enable SE. The counter 19, receiving input of the charge enable CE, outputs a charge enable CE with a delay time given as the delay time d1. Also, the counter 19, receiving input of the power supply enable RE, outputs a power supply enable RE with a delay time equal to a total time of the delay time d1 and the delay time d2.

### Configuration example 2 of delay control circuit 16

The delay control circuit 16 allows the following internal configuration to be adopted instead of the above-described internal configuration example. FIG. 9 is a diagram showing an internal configuration of the delay control circuit 16 which is another example. As shown in FIG. 9, the delay control circuit 16 of this configuration example includes a constant current source 20, a comparator 21, a threshold-voltage generation circuit 22, a switch SWn, and a capacitor C1.

The constant current source 20 is connected to the internal power supply circuit 15 and a node n2. A noninverting input terminal (+) of the comparator 21 is connected to the node n2. An inverting input terminal (-) of the comparator 21 is connected to the threshold-voltage generation circuit 22. A first terminal of the switch SWn is connected to the node n2. A second terminal of the switch SWn is connected to a grounding terminal GND. The capacitor C1 is externally connected via a terminal Tn to the light-emission drive device 6 between the terminal Tn and a grounding terminal GND. The terminal Tn is connected to the node n2 and the capacitor C1.

The constant current source 20, upon receiving supply of the battery voltage Vb, generates a constant current I2. The switch SWn is turned on upon receiving input of the high-level enable signal E1. Also, the switch SWn is turned off upon receiving input of the low-level enable signal E1. The threshold-voltage generation circuit 22 generates a threshold voltage Vth1 which is a specified constant voltage. The comparator 21 outputs a charge enable CE in response to a comparison result between a voltage of the node n2 and the threshold voltage Vth1.

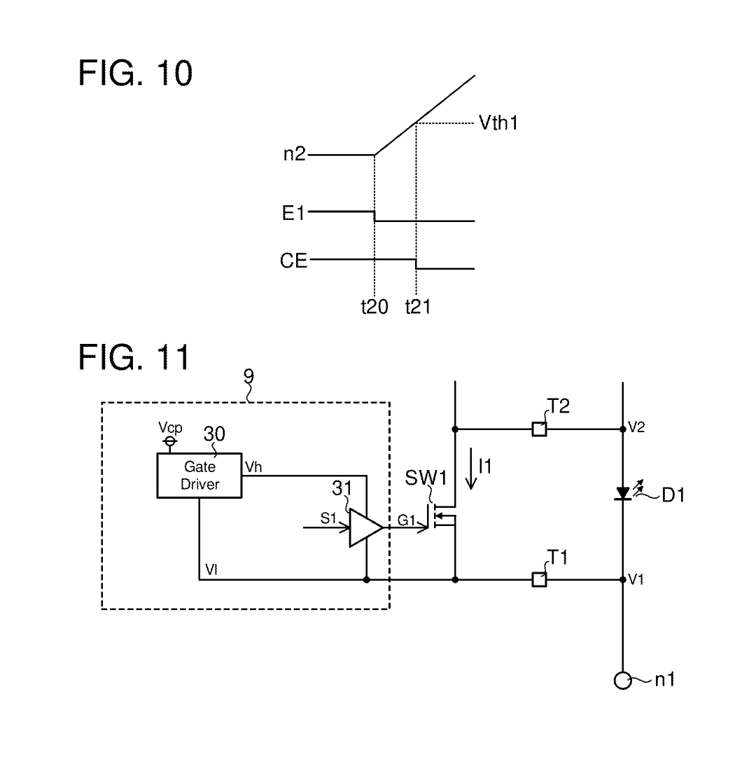

FIG. 10 is a timing chart showing internal control in this configuration example. As shown in FIG. 10, when the enable signal E1 is at high level (before time t20 in FIG. 10), the switch SWn has been turned on as described above. Therefore, the constant current I2 flows to the grounding terminal GND, so that the capacitor C1 is not charged. As a result, the voltage of the node n2 is under the threshold voltage Vth1. Consequently, in this case, the comparator 21 holds the charge enable CE at high level.

When the enable signal E1 falls to low level, the switch SWn is turned off as described above. Then, the constant current I2 flows into the capacitor C1, causing the capacitor C1 to be charged. As a result, the voltage of the node n2 increases. At time t21 which is a lapse of delay time d1 after time t20, the voltage of the node n2 goes over the threshold voltage Vth1. Consequently, as the time t21 has come up, the comparator 21 lowers the charge enable CE to low level.

The delay time d1 is determined depending on a capacitance of the capacitor C1. The capacitor C1 is externally connected to the light-emission drive device 6. Therefore, a capacitor C1 of arbitrary capacitance, which is selected so as to obtain a desired delay time d1, is connected to the terminal Tn.

### Configuration example of gate driver 9 to 12

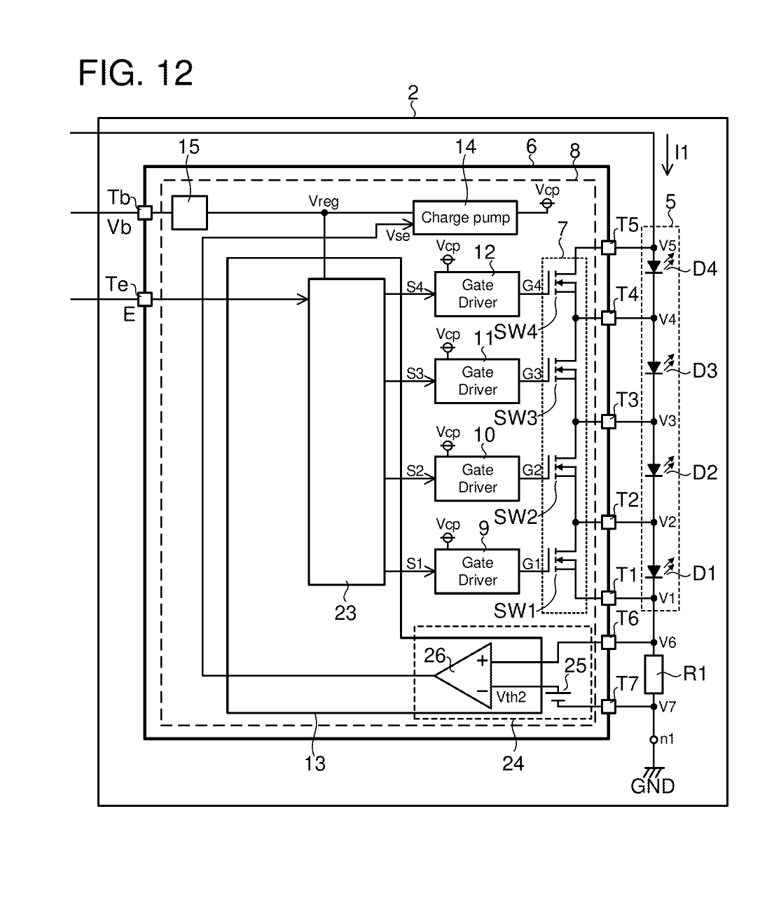

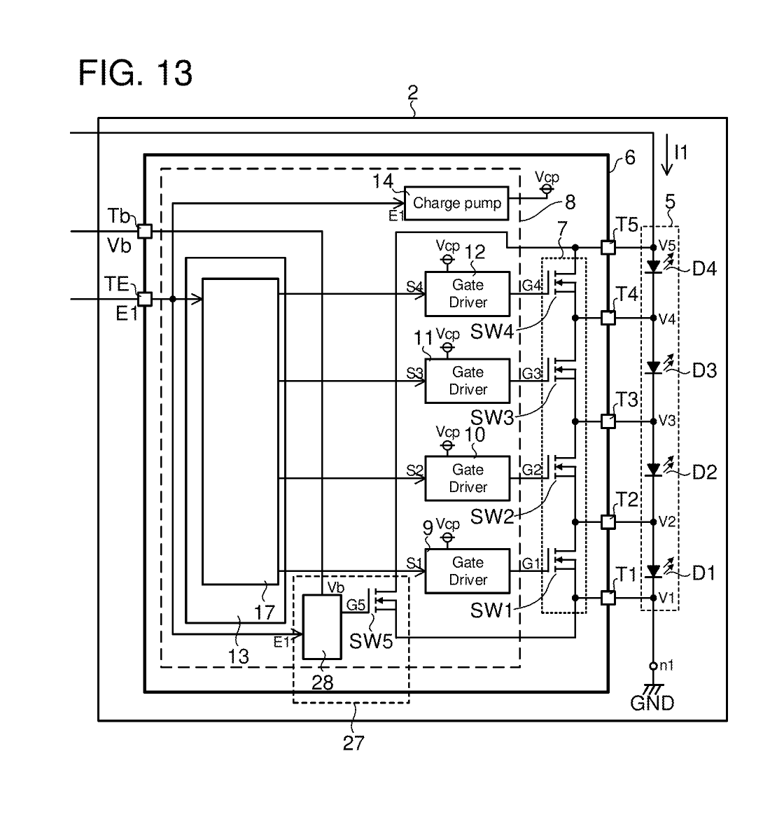

Here is described a configuration example of the gate drivers 9 to 12. FIG. 11 is a diagram showing a configuration of a gate driver 9. Since the gate drivers 9 to 12 are basically common there among in configuration, a description will be given on the gate driver 9, with the gate drivers 10 to 12 omitted in description.

A shown in FIG. 11, the gate driver 9 includes a regulator 30 and a drive circuit 31. The regulator 30, upon receiving supply of the charge voltage Vcp, steps down the charge voltage Vcp to generate a high-side voltage Vh and a low-side voltage Vl.

An input terminal of the drive circuit 31 receives input of a control signal S1. A high-side power supply terminal of the drive circuit 31 receives input of the high-side voltage Vh. A low-side power supply terminal of the drive circuit 31 receives input of the low-side voltage Vl. The drive circuit 31, upon receiving supply of the high-side voltage Vh and the low-side voltage Vl, outputs a drive signal G1. More specifically, in order to set the drive signal G1 to high level, the drive circuit 31 sets the drive signal G1 to an equivalent of the high-side voltage Vh. Conversely, in order to set the drive signal G1 to low level, the drive circuit 31 sets the drive signal G1 to an equivalent of the low-side voltage Vl.

As described above, high-level voltage values of the drive signals G1 to G4 are increasingly higher in order of the drive signals G1 to G4. Therefore, the regulators 30 of the gate drivers 9 to 12 generate such high-side voltages Vh as are increasingly higher in order of the gate drivers 9 to 12. This is explained below in detail.

The regulator 30 of the gate driver 9 generates a high-side voltage Vh equivalent to the high-level drive signal G1. The regulator 30 of the gate driver 10 generates a high-side voltage Vh equivalent to the high-level drive signal G2. The regulator 30 of the gate driver 11 generates a high-side voltage Vh equivalent to the high-level drive signal G3. The regulator 30 of the gate driver 12 generates a high-side voltage Vh equivalent to the high-level drive signal G4.

### Light-emitting device 2 according to second embodiment

Next, a light-emitting device 2 according to a second embodiment will be described in detail. The light-emitting device 2 of this embodiment is basically common in configuration to that of the first embodiment. Therefore, components common to the first embodiment are denoted by like reference signs with their description omitted; configuration different from the first embodiment will principally be explained.

FIG. 12 is a diagram showing a light-emitting device 2 according to the second embodiment. As shown in FIG. 12, a main control circuit 13 of this embodiment includes a driver control circuit 23 and a current sense circuit 24. Also, a sense resistor R1 is externally connected to the light-emitting device 2 of this embodiment via a terminal T6 and a terminal T7.

A first terminal of the sense resistor R1 is connected to the terminal T6 and a cathode of the light-emitting element D1. Also, a second terminal of the sense resistor R1 is connected to the terminal T7 and a node n1.

In a case where the drive current I1 is supplied to the light-emitting device 2, a current flows from the cathode of the light-emitting element D1 or the terminal T1 to the sense resistor R1. Then, a voltage V6 responsive to a resistance value of the sense resistor R1 is developed across the sense resistor R1.

The driver control circuit 23 receives input of an enable signal E1. The driver control circuit 23, receiving input of the high-level enable signal E1, generates control signals S1 to S4 of arbitrary logic levels to control the gate drivers 9 to 12 so that any arbitrary one of light-emitting elements D1 to D4 goes to any arbitrary light emission state. Also, the driver control circuit 23, receiving input of the low-level enable signal E1, generate low-level control signals S1 to S4 to control the gate drivers 9 to 12 so that the light-emitting elements D1 to D4 are turned off.

The current sense circuit 24 is configured to detect whether or not a current is flowing in the sense resistor R1, and to generate a current sense signal Vse in response to a detection result. The current sense signal Vse is a digital signal that is changeable between binary logic levels, high level or low level. The current sense circuit 24 inputs the current sense signal Vse to the charge pump 14.

The charge pump 14 of this embodiment, receiving input of the high-level current sense signal Vse, generates a charge voltage Vcp based on the battery voltage Vb. Also, the charge pump 14 of this embodiment, receiving input of the low-level current sense signal Vse, ends generation of the charge voltage Vcp.

A concrete configuration of the current sense circuit 24 is as follows. The current sense circuit 24 includes a threshold-voltage generation circuit 25 and a comparator 26. The threshold-voltage generation circuit 25 generates a threshold voltage Vth2, which is a specified constant voltage.

A noninverting input terminal (+) of the comparator 26 is connected to the terminal T6. An inverting input terminal (-) of the comparator 26 is connected to the threshold-voltage generation circuit 25.

To the noninverting input terminal (+) of the comparator 26, a voltage V6 is applied via the terminal T6. To the inverting input terminal (-) of the comparator 26, a threshold voltage Vth2 is applied. The comparator 26 generates a current sense signal Vse responsive to a comparison result between the voltage V6 and the threshold voltage Vth2, inputting the signal to the charge pump 14.

For example, when the voltage V6 is over the threshold voltage Vth2 (i.e., when the drive current I1 exceeds a specified current value), the comparator 26 sets the current sense signal Vse to high level. In this state, assume that the enable signal E1 has fallen from high to low level. Then, as described above, the driver control circuit 23 sets the control signals S1 to S4 to high level to turn on the switch elements SW1 to SW4. Therefore, the light-emitting elements D1 to D4 come to a current withdrawal state, causing the light-emitting elements D1 to D4 to be turned off. In this case, the drive current I1 flows via the terminal T1 into the sense resistor R1.

Assume that there has occurred a lag between the enable signal E1 and the enable signal E2 as described above. Further, assume that the enable signal E1 has fallen to low level while the drive current I1 is being supplied to the light-emitting device 2. In this case, as far as the drive current I1 is supplied over a specified quantity to the light-emitting device 2, the current sense signal Vse is held at high level as described above. Therefore, even when the enable signal E1 has fallen to low level, the charge pump 14 continues generating the charge voltage Vcp until the current value of the drive current I1 becomes lower than a specified value (i.e., the voltage V6 becomes lower than the threshold voltage Vth2) such that the threshold-voltage generation circuit 25 no longer detects the drive current I1. Accordingly, the switch elements SW1 to SW4 can be held in on-status while the drive current I1 is supplied to the light-emitting device 2. Thus, it can be prevented that the light-emitting elements D1 to D4 flash at halt timings of the light-emitting system 100.

### Light-emitting device 2 according to third embodiment

Next, a light-emitting device 2 according to a third embodiment will be described in detail. The light-emitting device 2 of this embodiment is also basically common in configuration to the first embodiment. Therefore, components common to the first embodiment are denoted by like reference signs with their description omitted; configuration different from the first embodiment will principally be explained.

FIG. 13 is a diagram showing the light-emitting device 2 according to the third embodiment. As shown in FIG. 13, a light-emission drive device 6 according to this embodiment includes, in addition to a bypass circuit 7, another bypass circuit 27 different from the bypass circuit 7. The bypass circuit 27 detects a falling edge of the enable signal E1 to low level, making the drive current I1 flow to a grounding terminal via the bypass circuit 27 itself, with a result that the light-emitting elements D1 to D4 are brought into a current withdrawal state. This is explained below in detail.

The bypass circuit 27 includes a switch element SW5 and a driver control circuit 28. The switch element SW5 is an N-channel MOSFET. A source of the switch element SW5 is connected to the terminal T1 together with the source of the switch element SW1. A drain of the switch element SW5 is connected to the terminal T5 together with the drain of the switch element SW4. A gate of the switch element SW5 receives input of a drive signal G5.

The switch element SW5, receiving input of the high-level drive signal G5 to its own gate, is turned on. Conversely, the switch element SW5, receiving input of the low-level drive signal G5 to its own gate, is turned off.

The driver control circuit 28 operates on supply of the battery voltage Vb. Also, the driver control circuit 28 receives input of the enable signal E1. The driver control circuit 28, receiving input of the high-level enable signal E1, sets the drive signal G5 to low level. Further, the driver control circuit 28, upon detecting a falling edge of the enable signal E1 to low level, raises up the drive signal G5 to high level.

The charge pump 14 of this embodiment, upon input of the high-level enable signal E1, generates a charge voltage Vcp. Also, the charge pump 14, upon input of the low-level enable signal E1, halts generation of the charge voltage Vcp.

The main control circuit 13 of this embodiment includes a driver control circuit 29. The driver control circuit 29, receiving input of the high-level enable signal E1, generates control signals S1 to S4 of arbitrary logic levels to control the gate drivers 9 to 12, respectively, so that any arbitrary one or ones of the light-emitting elements D1 to D4 go to any arbitrary light-emission states. Also, the driver control circuit 29, receiving input of the low-level enable signal E1, generates the low-level control signals S1 to S4 to control the gate drivers 9 to 12 so that the light-emitting elements D1 to D4 are turned off.

Assume that the ECU 200 has lowered the enable signal E to low level. In this case, the charge pump 14, the driver control circuit 28, and the driver control circuit 29 receive input of the low-level enable signal E1. Then, the charge pump 14 halts generation of the charge voltage Vcp as described above.

In this case also, the driver control circuit 28 sets the drive signal G5 to high level. Then, as described above, the switch element SW5 is turned on. As a result of this, even when the charge pump 14 has halted the charge voltage Vcp with the drive current I1 being supplied to the light-emitting device 2 so that the switch elements SW1 to SW4 can no longer be held at on-status, the drive current I1 withdraws from the light-emitting elements D1 to D4, flowing via the switch element SW5 and the terminal T1 to the node n1. Thus, flashlight of the light-emitting elements D1 to D4 like the above-described one can be suppressed.

### Light-emitting system 100 equipped with a plurality of light-emitting devices 2

The light-emitting system 100 in each one of the above-described embodiments may be so configured as to be equipped with a plurality of light-emitting devices 2. For example, a light-emitting system 100 equipped with a plurality of light-emitting devices 2 according to the first embodiment is configured as described below.

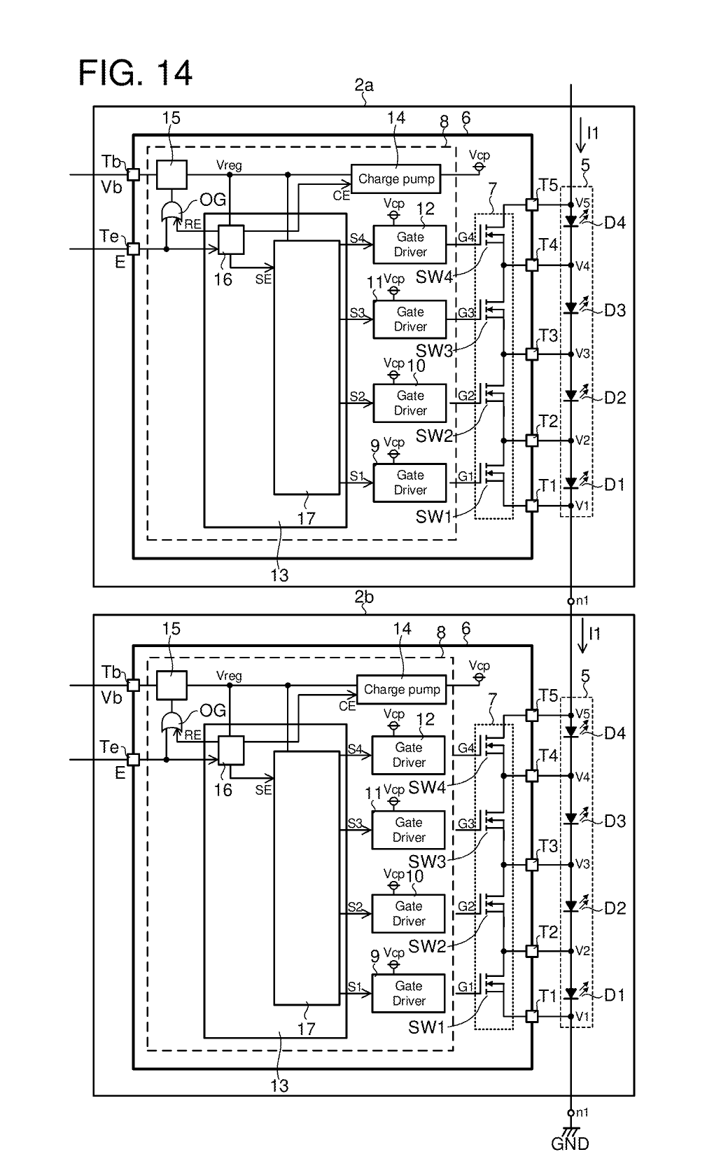

FIG. 14 shows a light-emitting system 100 equipped with a plurality of light-emitting devices 2. As shown in FIG. 14, the light-emitting system 100 of this configuration example includes a first light-emitting device 2a and a second light-emitting device 2b. Each of the first light-emitting device 2a and the second light-emitting device 2b is equivalent to the foregoing light-emitting device 2. The above-described node n1 serves as a connecting node between the terminal T1 of the light-emitting device 2a and the terminal T5 of the light-emitting device 2b. The terminal T1 of the light-emitting device 2b is connected to the grounding terminal together with the cathode of the light-emitting element D1.

The enable signal E1 is inputted to both the enable terminal Te of the light-emitting device 2a and the enable terminal Te of the light-emitting device 2b.

With adoption of a configuration in which the light-emitting system 100 is equipped with a plurality of light-emitting devices 2 (light-emitting devices 2a, 2b in the case of FIG. 14) as in this configuration example, the above-described flashlight can be suppressed as to the light-emitting system 100 equipped with a multiplicity of light-emitting elements. In addition, the light-emitting device 2 in this case is not limited to the one according to the first embodiment, and may be the light-emitting device 2 according to the second embodiment or the light-emitting device 2 according to the third embodiment.

### Modifications

Otherwise, the present disclosure is not limited to the above-described embodiments and may be changed or modified in various ways without departing from the gist of the disclosure. For example, although the enable signal E is inputted to the switch SWn (see FIG. 9) in the above description, the switch drive enable SE may be substituted for the enable signal E.

Also, for example, although the light-emitting element array 5 in the above-described embodiments includes the light-emitting elements D1 to D4, yet two light-emitting elements may be included, or five or more light-emitting elements may be included, in the light-emitting element array 5 as an example.

A light-emission drive device (6) disclosed herein is configured to include: a bypass circuit (7) configured to switch over between an inflow state, in which a drive current (I1) is made to flow into each of light-emitting elements (D1 to D4) connected in series in plurality, and a withdrawal state, in which the drive current (I1) is made not to flow but to be withdrawn; and a bypass control circuit (8) configured to control the bypass circuit (7) in such a way that when an externally inputted enable signal (E, E1, E2) is at a first logic level, the drive current (I1) is made to flow into, or be withdrawn from, each of the light-emitting elements (D1 to D4), and when the enable signal (E, E1, E2) is at a second logic level, the drive current (I1) is made to flow into none of the light-emitting elements (D1 to D4) but to be withdrawn from all the light-emitting elements (D1 to D4) until the drive current (I1) becomes less than a specified current value (first configuration).

The light-emission drive device (6) according to the first configuration may appropriately be so configured that the bypass circuit (7) includes a plurality of switch elements (SW1 to SW4) connected in parallel to the light-emitting elements (D1 to D4), respectively, so that for on-status, the drive current (I1) is withdrawn from the light-emitting elements (D1 to D4) to the bypass circuit itself so as to be blocked from flowing to the light-emitting elements (D1 to D4), and for off-status, the drive current (I1) is allowed to flow to the light-emitting elements (D1 to D4) (second configuration).

The light-emission drive device (6) according to the first or second configuration may appropriately be configured that the bypass control circuit (8) includes: a delay control circuit (16) configured to generate a first control signal (SE), and a second control signal (CE) obtained by adding a specified delay time (d1) to the first control signal (SE), on a basis of at least one of logic level of the enable signal (E, E1, E2) and the drive current (I1); an operating-voltage generation circuit (14) configured to generate a first operating voltage (Vcp) in response to the second control signal (CE); and a drive control circuit (17) configured to drive the bypass circuit (7) so that upon receiving supply of the first operating voltage (Vcp), the bypass circuit switches over between the inflow state and the withdrawal state for the light-emitting elements (D1 to D4) on a basis of the first control signal (SE) (third configuration).

The light-emission drive device (6) according to the third configuration may appropriately be so configured that the delay control circuit (16) operates to: upon receiving input of the first-logic-level enable signal (E, E1, E2), set the first control signal (SE) to a third logic level; upon receiving input of the second-logic-level enable signal (E, E1, E2), set the first control signal (SE) to a fourth logic level; and when the delay time (d1) has elapsed since a timing at which the enable signal (E, E1, E2) is switched over from the first logic level to the second logic level, switch over the second control signal (CE) from the third logic level to the fourth logic level, and the operating-voltage generation circuit (14) operates to: upon receiving input of the third-logic-level first control signal (SE), generate the first operating voltage (Vcp), and upon receiving input of the fourth-logic-level first control signal (SE), halt generation of the first operating voltage (Vcp) (fourth configuration).

The light-emission drive device (6) according to the first configuration may appropriately be so configured that the bypass control circuit (8) includes: a current sense circuit (24) configured to sense the drive current (I1) and generate a sense signal responsive to a sense result; and a drive control circuit (17) configured to drive the bypass circuit (7) so that upon receiving supply of the first operating voltage (Vcp), the bypass circuit switches over between the inflow state and the withdrawal state for the light-emitting elements (D1 to D4), on a basis of the enable signal (E, E1, E2) (fifth configuration).

The light-emission drive device (6) according to the first configuration may appropriately be so configured that the bypass circuit (7) includes: a second bypass circuit (27) which is connected in parallel to a light-emitting element array (5) composed of the light-emitting elements (D1 to D4) and which is configured to make the drive current (I1) flow to the light-emitting element array (5) or make the drive current (I1) withdrawn from the light-emitting element array (5) so that the drive current (I1) flows to none of the light-emitting elements (D1 to D4); and a first bypass circuit (7) which is connected in parallel to the light-emitting elements (D1 to D4) and which is so configured that the drive current (I1), while flowing into the light-emitting element array (5), is switched over between the inflow state and the withdrawal state for each one of the light-emitting elements (D1 to D4), and the bypass control circuit (8) includes: an operating-voltage generation circuit (14) configured to generate a first operating voltage (Vcp) responsive to the enable signal (E, E1, E2); a first-bypass drive control circuit (29) configured to, upon receiving supply of the first operating voltage (Vcp), drive the first bypass circuit (7) so as to switch over between the inflow state and the withdrawal state for the light-emitting elements (D1 to D4); and a second-bypass drive control circuit (28) which is configured to operate based on a second operating voltage (Vcp) supplied from external and to drive the second bypass circuit (27) in response to the enable signal (E, E1, E2) (sixth configuration).

The light-emission drive device (6) according to any one of the first to sixth configurations may appropriately be so configured that the bypass circuit (7) and the bypass control circuit (8) are integrated together (seventh configuration).

A light-emitting device (2) disclosed herein may appropriately be configured to include a plurality of the light-emitting elements (D1 to D4), and the light-emission drive device (6) according to any one of the first to seventh configurations (eighth configuration).

The light-emitting device (2) according to the eighth configuration may appropriately be so configured that the light-emission drive device (6) is provided in plurality (ninth configuration).

A light-emitting system (100) disclosed herein is configured to include the light-emitting device (2) according to the eighth or ninth configuration, and a power supply device (1) configured to generate the drive current (I1) based on the enable signal (E, E1, E2) and supply the drive current (I1) to the light-emitting device (2) (tenth configuration).

The light-emitting system (100) according to the tenth configuration may appropriately be so configured that the power supply device (1) includes: a booster circuit (3) configured to generate a boost voltage (Vo) obtained by boosting a power supply voltage (Vb) supplied from external based on the enable signal (E, E1, E2); and a drive-current generation circuit (4) configured to generate the drive current (I1) through current-voltage conversion of the boost voltage (Vo) (eleventh configuration).

What is claimed is:

1. A light-emission drive device comprising:
a bypass circuit configured to switch over between an inflow state, in which a drive current is made to flow into each of light-emitting elements connected in series in plurality, and a withdrawal state, in which the drive current is made not to flow but to be withdrawn; and
a bypass control circuit configured to control the bypass circuit in such a way that when an externally inputted enable signal is at a first logic level, the drive current is made to flow into, or be withdrawn from, each of the light-emitting elements, and when the enable signal is at a second logic level, the drive current is made to flow into none of the light-emitting elements but to be withdrawn from all the light-emitting elements until the drive current becomes less than a specified current value.

2. The light-emission drive device as claimed in claim 1, wherein
the bypass circuit includes a plurality of switch elements connected in parallel to the light-emitting elements, respectively, so that for on-status, the drive current is withdrawn from the light-emitting elements to the bypass circuit itself so as to be blocked from flowing to the light-emitting elements, and for off-status, the drive current is allowed to flow to the light-emitting elements.

3. The light-emission drive device as claimed in claim 1, wherein
the bypass control circuit includes:
a delay control circuit configured to generate a first control signal, and a second control signal obtained by adding a specified delay time to the first control signal, on a basis of at least one of logic level of the enable signal and the drive current;
an operating-voltage generation circuit configured to generate a first operating voltage on a basis of the second control signal; and
a drive control circuit configured to drive the bypass circuit so that upon receiving supply of the first operating voltage, the bypass circuit switches over between the inflow state and the withdrawal state for the light-emitting elements on a basis of the first control signal.

4. The light-emission drive device as claimed in claim 3, wherein
the delay control circuit operates to:
upon receiving input of the first-logic-level enable signal, set the first control signal to a third logic level;
upon receiving input of the second-logic-level enable signal, set the first control signal to a fourth logic level; and
when the delay time has elapsed since a timing at which the enable signal is switched over from the first logic level to the second logic level, switch over the second control signal from the third logic level to the fourth logic level, and
the operating-voltage generation circuit operates to:
upon receiving input of the third-logic-level first control signal, generate the first operating voltage, and
upon receiving input of the fourth-logic-level first control signal, halt generation of the first operating voltage.

5. The light-emission drive device as claimed in claim 1, wherein
the bypass control circuit includes:
a current sense circuit configured to sense the drive current and generate a sense signal responsive to a sense result;
an operating-voltage generation circuit configured to generate a first operating voltage based on the sense signal at least under a condition that the drive current has been sensed; and
a drive control circuit configured to drive the bypass circuit so that upon receiving supply of the first operating voltage, the bypass circuit switches over between the inflow state and the withdrawal state for the light-emitting elements, on a basis of the enable signal.

6. The light-emission drive device as claimed in claim 1, wherein
the bypass circuit includes:
a second bypass circuit which is connected in parallel to a light-emitting element array composed of the light-emitting elements and which is configured to make the drive current flow to the light-emitting element array or make the drive current withdrawn from the light-emitting element array so that the drive current flows to none of the light-emitting elements; and
a first bypass circuit which is connected in parallel to the light-emitting elements and which is so configured that the drive current, while flowing into the light-emitting element array, is switched over between the inflow state and the withdrawal state for each one of the light-emitting elements, and
the bypass control circuit includes:
an operating-voltage generation circuit configured to generate a first operating voltage responsive to the enable signal;
a first-bypass drive control circuit configured to, upon receiving supply of the first operating voltage, drive the first bypass circuit so as to switch over between the inflow state and the withdrawal state for the light-emitting elements; and
a second-bypass drive control circuit which is configured to operate based on a second operating voltage supplied from external and to drive the second bypass circuit in response to the enable signal.

7. The light-emission drive device as claimed in claim 1, wherein the bypass circuit and the bypass control circuit are integrated together.

8. A light-emitting device comprising:
a plurality of the light-emitting elements; and
the light-emission drive device as claimed in claim 1.

9. The light-emitting device as claimed in claim 8, wherein the light-emission drive device is provided in plurality.

10. A light-emitting system comprising:
the light-emitting device as claimed in claim 9; and
a power supply device configured to generate the drive current based on the enable signal and supply the drive current to the light-emitting device.

11. The light-emitting system as claimed in claim 10, wherein
the power supply device includes:
a booster circuit configured to generate a boost voltage obtained by boosting a power supply voltage supplied from external based on the enable signal; and
a drive-current generation circuit configured to generate the drive current through current-voltage conversion of the boost voltage.
